(19) United States
(12) Patent Application Publication
(10) Pub. No.: US 2009/0026261 A1
(43) Pub. Date: Jan. 29, 2009

(54) CONTROL GATE

(75) Inventors: Hiroyoshi INOUE, Kanagawa (JP); Shoji YAMAGUCHI, Kanagawa (JP); Yasunori KODA, Kanagawa (JP); Kunihiro TAKAHASHI, Kanagawa (JP); Mario FUSE, Kanagawa (JP); Tsukasa MATSUDA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/179,155

(22) Filed: Jul. 24, 2008

(30) Foreign Application Priority Data
Jul. 26, 2007 (JP) 2007-194262

(51) Int. Cl. G06K 5/00

(52) U.S. Cl. 235/382

(57) ABSTRACT

A control gate includes a first exciting coil, a first detection coil, a second exciting coil, a second detection coil, a signal determination unit and an amplification factor setting unit. The first exciting coil forms a first alternating magnetic field in a passage. The first detection coil detects a variation in the first alternating magnetic field. The second exciting coil forms a second alternating magnetic field in the passage. The second detection coil that detects a variation in the second magnetic field. The signal determination unit includes a first amplifier which (i) amplifies a first detection signal of the first detection coil and (ii) determines a passage of the magnetic material based on the amplified first detection signal. The amplification factor setting unit sets a first amplification factor for the first amplifier based on a second detection signal of the second detection coil.

### CROSS-REFERENCE TO RELATED APPLICATIONS

This application is based on and claims priority under 35 USC 119 from Japanese Patent Application No. 2007-194262 filed Jul. 26, 2007.

### BACKGROUND

1. Technical Field

The present invention relates to a control gate for controlling the passage of an object which is restricted from being carried out or carried in by detecting a magnetic field variation produced by magnetic inversion of a magnetic material which produces a large Barkhausen effect.

2. Related Art

As a control gate for detecting the passage of an object which is prohibited from being carried out or carried in and issuing a warning about the passage, a control gate which makes use of a magnetic material generating a large Barkhausen effect is known.

As the magnetic material generating a large Barkhausen effect, a Fe—Co based amorphous metallic thin wire or the like is known. This magnetic material generates therein drastic magnetic inversion by being imparted an alternating magnetic field which surpasses its magnetic coerective force, whereby a variation in magnetic field is produced. Consequently, in the event that the magnetic material which generates a large Barkhausen effect is affixed to an object which is restricted from being carried out or carried in, the passage of the object through the control gate can be detected by detecting the magnetic field variation.

By installing a control gate like this at an entrance to and exit from a control area where the egress and ingress of objects are controlled which are prohibited from being carried out or carried in, carrying out or carrying in of such an object can be controlled.

### SUMMARY

According to an aspect of the invention, a control gate includes a first exciting coil, a first detection coil, a second exciting coil, a second detection coil, a signal determination unit and an amplification factor setting unit. The first exciting coil forms a first alternating magnetic field in a passage leading to an area where objects are controlled to be carried in and carried out. The first detection coil detects a variation in the first alternating magnetic field, which is produced by magnetic inversion of a magnetic material generating the large Barkhausen effect within the first alternating magnetic field formed by the first exciting coil. The second exciting coil (i) is disposed in a path which is approaches to a position where the first exciting coil and the first detection coil are disposed and (ii) forms a second alternating magnetic field in the passage. The second detection coil detects a variation in the second magnetic field, which is produced by magnetic inversion of the magnetic material generating the large Barkhausen effect within the second alternating magnetic field formed by the second exciting coil. The signal determination unit includes a first amplifier which (i) amplifies a first detection signal of the first detection coil and (ii) determines a passage of the magnetic material generating the large Barkhausen effect based on the amplified first detection signal. The amplification factor setting unit sets a first amplification factor for the first amplifier based on a second detection signal of the second detection coil.

### BRIEF DESCRIPTION OF THE DRAWINGS

Exemplary embodiment(s) of the present invention will be described in detail based on the following figures, wherein:

FIG. 1 is a schematic drawing showing an example of a control system using control gates, which is an exemplary embodiment of the invention;

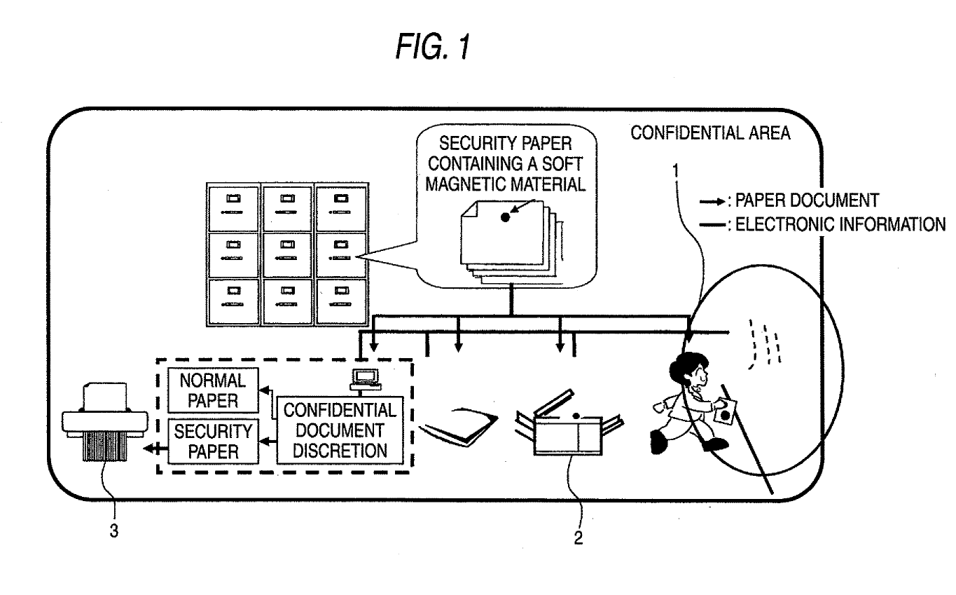

FIGS. 2A and 2B are schematic block diagrams of the control gate according to the exemplary embodiment of the invention;

FIG. 3 is a conceptual drawing of a sheet of recording paper which utilizes a magnetic material which generates a large Barkhausen effect;

FIG. 4 is a schematic block diagram of a signal processing unit which is used in the control gate shown in FIG. 2; and

FIG. 5 is a schematic drawing showing a signal saturation state in the control gate.

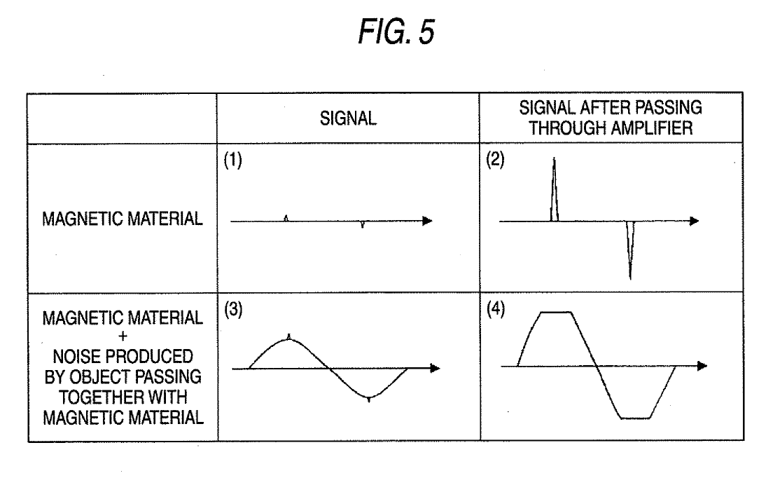

### DETAILED DESCRIPTION

Hereinafter, a control gate which is an exemplary embodiment of the invention will be described based on the drawings.

This control gate 1 is a gate for detecting a confidential document included in an object and is disposed at an entrance to and exit from an area where the confidential document is stored, thereby provides a preventive measure against an action to carry out a confidential document illegally or erroneously.

In an area where confidential matters are held, confidential matters are stored in the form of documents or electronic information, and documents are prepared by a printer or a photo copier 2. As this occurs, a confidential document is prepared by utilizing so-called security paper which contains a magnetic material which generates a large Barkhausen effect. In addition, the confidential document so prepared is disposed of by a shredder 3 within the confidential matters control area.

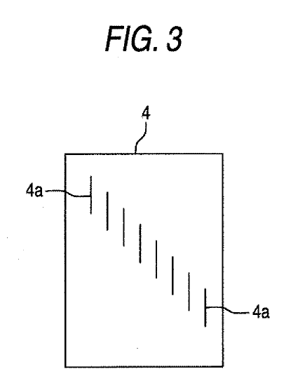

As the security paper, one shown, for example, in FIG. 3 can be employed.

In this security paper 4, magnetic materials 4a which generate a large Barkhausen effect are embedded in the form of linear materials in fibers making up the security paper. The magnetic materials 4a may be contained in the security paper in such a manner as to be dispersed over substantially the whole area of the paper. And the magnetic materials may be disposed in a regular fashion as is shown in FIG. 3. In addition, the magnetic materials may be embedded within fibers of the paper in such a manner as not to easily be removed. As the magnetic material, for example, an Fe—Co based amorphous metallic thin wire (whose diameter is several tens μm and length is 1 mm or longer), and in addition to this, soft magnetic materials which generate a large Barkhausen effect can be used.

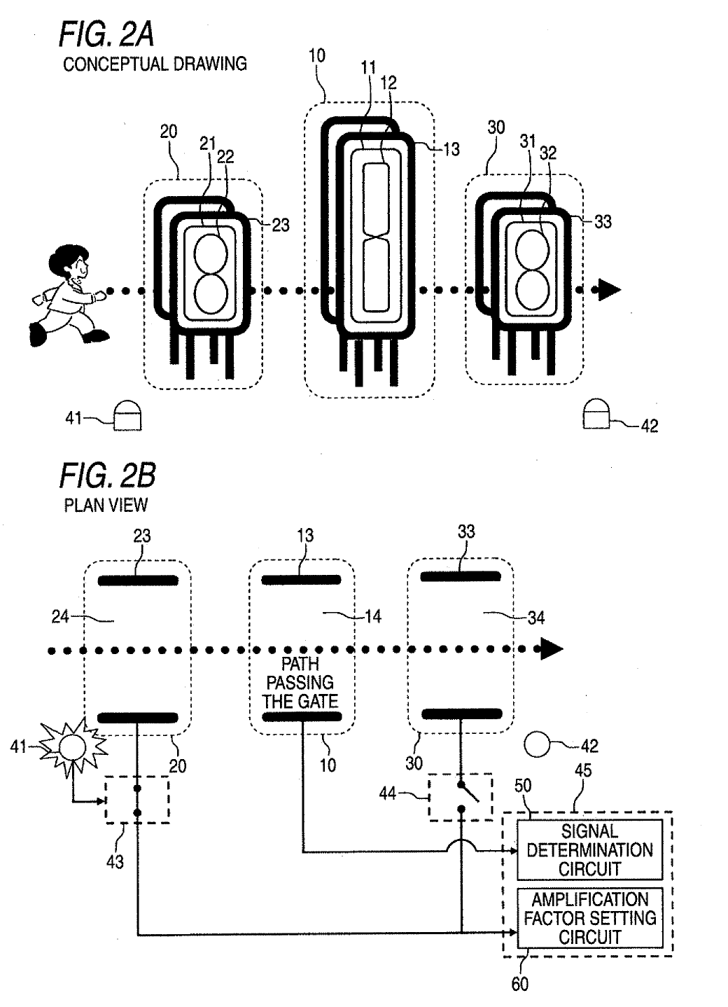

FIG. 2 is a schematic block diagram showing a control gate provided at an entrance to and exit from the control area.

This control gate 1 includes a first detection gate 10 which detects a magnetic material which generates a large Barkhausen effect, a second detection gate 20 and a third detection gate 30 which detect a signal level when detecting a signal due to the large Barkhausen effect, a signal processing unit 45 that determines the existence of a magnetic material which generates a large Barkhausen effect based on outputs from these detection gates, and person detection sensors 41, 42 which detect a person who passes through the second detection gate and the third detection gate.

The first detection gate 10 is provided in such a manner as to face a passage which goes into and comes out of the area where objects to be carried out are controlled and has a first exciting coil 11 which forms an alternating magnetic field and a first detection coil 12 which detects a variation in magnetic field as a result of a magnetic inversion occurring in the magnetic material generating a large Barkhausen effect within the magnetic field that is formed by the exciting coil 11. These first exciting coil 11 and first detection coil 12 are accommodated in each of panel-like accommodation cases 13 which are provided to be erected on both sides of the passage. The first exciting coil 11 is wound along a vertical plane which is parallel to a direction in which a person walks along the passage and is such as to generate an alternating magnetic field in the passage 14 when it is energized with an alternating current voltage from a power supply unit (not shown). In addition, the first detection coil 12 is wound into the shape of “8” inwards of the first exciting coil 11 and along a vertical plane which is parallel to a winding of the first exciting coil. This first detection coil 12 is such as to detect a variation in magnetic field which is occurring in a passage 14 as an induced current, and by being wound into the shape of “8”. Therefore, the first detection coil 12 is made to suppress an induced current which corresponds to a frequency component of the alternating current voltage energized to the first exciting coil 11.

The second detection gate 20 is provided on a path which approaches the first detection gate 10 on a farther side of the same gate from the control area and includes a second exciting coil 21 and a second detection coil 22, which are similar to those of the first detection gate 10. The second exciting coil 21 and the second detection coil 22 are provided on both sides of a passage 24 in such a manner as to face the passage 24, and the second exciting coil 21 forms an alternating magnetic field in the passage 24 and the second detection coil 22 is wound into the shape of “8” to detect an induced current generated by a variation in magnetic field. In addition, a first person detection sensor 41 is provided in a position corresponding to the position where the second detection gate 20 is provided. This first person detection sensor 41 detects a person who passes through the second detection gate 20, and may employ as a detection method, for example a method in which a light ray is emitted and a variation in the quantity of reflected light is detected or in which the interruption of a light ray which is emitted to a predetermined location.

The third detection gate 30 (i) is provided on a path which approaches the first detection gate 10 on a nearer side of the same gate 10 to the control area, (ii) has the same configuration as that of the second detection gate 20, (iii) includes a third exciting coil 31 and a third detection coil 32. In addition, a second person detection sensor 42 is provided in a position corresponding to the position where the third detection gate 30 is provided and the second person detection sensor 42 detects a person who passes through the third detection gate 30.

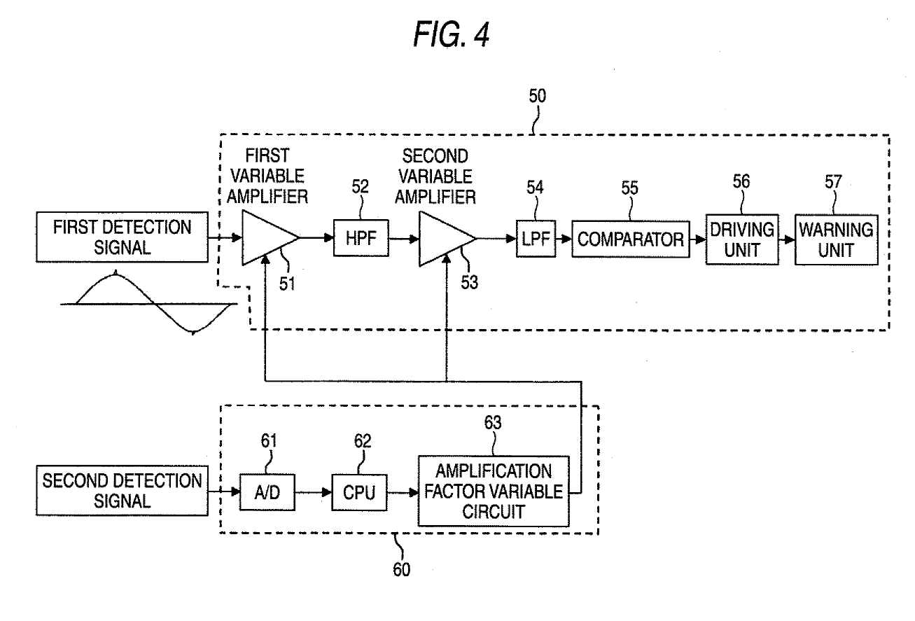

The signal processing unit 45 includes, as is shown in FIG. 28 and FIG. 4, a signal determination circuit 50 that determines the existence of a magnetic material generating a large Barkhausen effect based on outputs of the detection coils provided in the first detection gate (hereinafter, referred to as a first detection signal) and an amplification factor setting circuit 60 that sets an amplification factor for the first detection signal based on outputs of the second detection gate 20 or the third detection gate 30 (hereinafter, referred to as a second detection signal).

A signal that is detected by the detection coil 21 of the second detection gate 20 and a signal detected by the detection coil 31 of the third detection gate 30 are to be selected based on outputs of the person detection sensors 41, 42. Namely, when the first person detection sensor 41 detects a person, it is set that a first switch 43 is put in an ON state so that a signal outputted from the second detection gate 20 is inputted into the amplification factor setting circuit 60 as a second detection signal. In addition, when the second person detection sensor 42 detects a person, a second switch 44 is put in an ON state, so that a signal outputted from the third detection gate 30 is inputted into the amplification factor setting circuit 60 as a second detection signal.

The signal determination circuit 50 includes a first variable amplifier 51 that amplifies the first detection signal within a range where the signal is not saturated, a high-pass filter 52 which removes or reduces a low-frequency component which is lower than a signal that is generated by virtue of a large Barkhausen effect from the first detection signal, a second variable amplifier 53 that amplifies the signal that has passed through the high-pass filter 52 within a range where the signal is not saturated, a low-pass filter 54 that removes high-frequency noise from the signal that has passed through the second variable amplifier 53, a comparator 55 that compares the signal that has passed through the low-pass filter 54 with a reference data which is prepared in advance so as to determine whether or not a large Barkhausen signal is included, a driving unit 56 that interrupts the passage of the person when the comparator 55 determines that the large Barkhausen signal is included, and a warning unit 57 that issues a warning to the administrator when the driving unit 56 is actuated.

The first variable amplifier 51 amplifies the first detection signal inputted into the signal processing unit 45 with an amplification factor with which the output is not saturated, and this amplification factor is set by the amplification factor setting circuit 60.

The high-pass filter 52 removes or reduces the low-frequency component and allows the passage of the signal produced by the large Barkhausen effect which contains the high-frequency component. In particular, the high-pass filter 52 may removes or reduces a signal of the frequency component which is energized to the first exciting coil 11. In the event that a magnetic material such as a steel can is included in an object by the person, the magnetic field which is being generated by the first exciting coil 11 varies due to magnetization of the magnetic material such as the steel can, and a signal of the frequency component resulting from excitation is included in the detection signal at a high-level. The high-pass filter 52 can remove the signal produced by the magnetic material which isn't contained in the object to be controlled.

The second variable amplifier 53 amplifies the signal that has passed through the high-pass filter 52 with an amplification factor which falls within a range where the output is not saturated. By the frequency component of the voltage energized to the exciting coil being removed or reduced by the high-pass filter, the level of the signal is largely reduced, and the second variable amplifier 53 may further amplify the signal produced by the large Barkhausen effect within a range where the output therefrom is not saturated.

The low-pass filter 54 removes or reduces nose of a high-frequency component which is higher than the signal produced by the large Barkhausen effect from the signal that has passed through the second variable amplifier 53, whereby the accuracy of a determination carried out by the comparators which will be described later, is increased.

The comparator 55 determines whether or not the signal produced by the large Barkhausen effect is included in the first detection signal so amplified based on this signal. The signal by the large Barkhausen effect is detected as a pulse-shaped signal in accordance with the frequency of the voltage energized to the exciting coil. Consequently, the large Barkhausen signal is made to be determined based on the fact that it is the pulse-shaped signal and on its periodicity.

The driving unit 56 performs an opening and closing drive of a member such as a door adapted to interrupt the passage of the person who carries an object from which a large Barkhausen signal is detected and any device may be used as the driving unit 56 so long as it can restrict the movement of the person based on the result of a determination by the comparator 55.

In addition, this driving unit 56 is not limited to such as to be actuated only by the result of a determination by the comparator 55 and hence may be such as to be actuated based on the result of a comparison with the personal information of the person. For example, a driver can be adopted which is actuated based on personal information of the person which is inputted by him or her by means of a card or a condition such as time of passage.

The warning unit 57 informs the administrator of the result of a determination by the comparator 55, and issuance of a warning, illumination of a light, output of a warning sound, or distribution of an electronic mail to the administrator can be adopted as the unit for informing him or her of the result of the determination.

The amplification factor setting circuit 60 includes an A/D converter 61 that converts the second detection signal into a digital one, a CPU 62 that operates amplification factors for the first variable amplifier 51 and the second variable amplifier 53 based on the signal level of the digital signal, and an amplification factor variable circuit 63 that sets the amplification factor based on the result of the operation by the CPU 62 to the first variable amplifier 51 or the second variable amplifier 53.

The CPU 62 operates an amplification factor for each of the first variable amplifier 51 and the second variable amplifier 53 based on the signal level of the digitized second detection signal in such a manner that the output of each of the amplifiers does not surpass an upper limit value thereof, that is, in such a manner that an output signal is not saturated. In addition, to stabilize the accuracy of signal processing, the amplification factor may be set in such a manner that the level of the signal produced by the large Barkhausen effect becomes substantially constant.

For example, when a person carrying a piece of paper like the one shown in FIG. 3 goes past the first gate 10, a signal produced by a large Barkhausen effect can be detected as a signal of about 1 μV as is shown in Table 1. In contrast to this, when the person goes past the same first detection gate 10 while carrying a steel can containing drink, the signal level of a signal detected becomes on the order of 100 mV. To determine the existence of a signal produced by a large Barkhausen effect, a signal that is to be inputted into the comparator needs to be amplified to a level of the order of 1V. However, in the case of the amplification factor being made to be 120 dB in order to amplify the signal of 1 μV which is detected based on the passage of the piece of paper to 1 V, in the event that a steel can is carried together with the sheet of paper, a signal of about 100 mV is detected due to the inclusion of the steel can, and the signal is amplified to about 0.1 MV. The resulting signal surpasses the upper limit of the output of the first variable amplifier 51, and as is shown in the column (4) in FIG. 6, the signal produced by the large Barkhausen effect is lost and cannot be detected. Then, the amplification factor that is set on the first variable amplifier 51 is set so as not to surpass the upper limit of the output of the first variable amplifier 51 or is adjusted to, for example, 40 dB, whereby the loss of the signal produced by the large Barkhausen effect is avoided. Then, the amplification factor of the second variable amplifier 53 is operated so that a total sum of the amplification factors becomes 120 dB for a signal whose low-frequency component is reduced by the high-pass filter 52 so as to reduce the total signal level thereof.

TABLE 1

| | Variable | | Variable |
|---|---|---|---|
| | amplifier 1 (40 dB) | HPF | amplifier 2 (80 dB) |
| Signal security | 100 μV | 100 μV | 1 V |
| paper of 1 μV | | | |
| Signal steel can of | 10 V | 0 | 0 |
| 100 mV | | | |

When the amplification factors are set in the way described for the first variable amplifier 51 and the second variable amplifier 53, in the event that a large number of sheets of paper which contain the magnetic material to be controlled pass through the first detection gate 10 or that a large quantity of a magnetic material which isn't contained in the object to be controlled, that is, a large number of steel cans pass through the same gate, the levels of the first detection signal and the second detection signals become high, and the amplification factor of the first variable amplifier 51 is set so small that the saturation of the output signal is caused. In addition, when the level of the signal produced by the large Barkhausen effect is high, the amplification factor of the second variable amplifier 53 is set small to such an extent that the determination of the signal can be implemented properly.

Next, the operation of the control gate 1 will be described.

There is a person who is passing through the control gate 1, the approach of the person to the second detection gate 20 or the third detection gate 30 is detected by the person detection sensor 41 or 42 which is disposed to a position corresponding to the position of the second detection gate 20 or the third detection gate 30. Then, a signal detected by the detection coil of the detection gate which corresponds the person detection sensor which detects the passing person, that is, the detection signal detected by the detection coil of the second detection gate 20 or the third detection gate 30 is inputted into the amplification factor setting circuit 60 as a second detection signal. Thereafter, when the person enters the first detection gate 10, a variation in magnetic field produced within the magnetic field formed by the first exciting coil 11 is detected by the first detection coil 12, and the magnetic field variation so detected is then inputted into the signal determination circuit 50 as a first detection signal.

The second detection signal that has been inputted into the amplification factor setting circuit 60 is made into a digital signal and the signal level thereof is detected, based on which the amplification factor of the first variable amplifier 50 of the signal determination circuit 50 is operated. On the other hand, the first detection signal that has been inputted into the signal determination circuit 50 is amplified with the aforesaid amplification factor in the first variable amplifier 51. As this occurs, since the amplification factor of the first variable amplifier 51 is amplified within the range where a signal outputted therefrom is not saturated, even in the event that a large quantity of magnetic material is contained in the object which is carried by the passing person, there is caused no situation in which a signal outputted is saturated, and hence, there is caused no situation in which the signal produced by the large Barkhausen effect is lost. In addition, the S/N ratio can be increased largely by the first detection signal being amplified at the initial state of the processing, thereby makes it possible to determine the inclusion of the signal produced by the large Barkhausen effect with high accuracy.

The first detection signal amplified by the first variable amplifier 51 is passed through the high-pass filter 52, whereby the low-frequency component is removed or reduced. The signal level is reduced by this and is furthermore amplified by the second variable amplifier 53. As this occurs, too, the amplification factor of the second variable amplifier 53 is set by the amplification factor setting circuit 60 in such a way that the output signal is not saturated. Furthermore, the high-frequency noise is removed by the low-pass filter 54, and whether or not this signal includes the signal produced by the large Barkhausen effect is determined by the comparator 55. As this occurs, since the signal produced by the large Barkhausen effect is amplified properly and furthermore, the noise is reduced, the determination by the comparator 55 can be implemented with high accuracy. Then, the driving unit 56 and the warning unit 57 are actuated based on the result of the determination by the comparator 55.

The invention applied for patent by this patent application is not limited to the exemplary embodiment that has been described heretofore but can be modified into various modes. For example, as to the forms of the exciting coils and the detection coils of the first to third detection gates, an appropriate configuration and number of turns of a winding can be selected in accordance with positions where the detection gates are used and a type of object to be controlled. In addition, the positions where the detection gates are disposed are not limited to the sides of the passages, and hence, the detection gates may be disposed on the ceiling or floor.

In addition, the object to be controlled or detected is not limited to confidential documents and hence products or equipment may be adopted as the object to be detected, and consequently, various things can be made to be the object to be detected as long as a material generating a large Barkhausen effect is added thereto.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control gate comprising:
a first exciting coil that forms a first alternating magnetic field in a passage leading to an area where objects are controlled to be carried in and carried out;
a first detection coil that detects a variation in the first alternating magnetic field, which is produced by magnetic inversion of a magnetic material generating the large Barkhausen effect within the first alternating magnetic field formed by the first exciting coil;
a second exciting coil (i) that is disposed in a path which approaches to a position where the first exciting coil and the first detection coil are disposed and (ii) that forms a second alternating magnetic field in the passage;
a second detection coil that detects a variation in the second magnetic field, which is produced by magnetic inversion of the magnetic material generating the large Barkhausen effect within the second alternating magnetic field formed by the second exciting coil;
a signal determination unit that includes a first amplifier which (i) amplifies a first detection signal of the first detection coil and (ii) determines a passage of the magnetic material generating the large Barkhausen effect based on the amplified first detection signal; and
an amplification factor setting unit that sets a first amplification factor for the first amplifier based on a second detection signal of the second detection coil.

2. The control gate according to claim 1,
wherein the signal determination unit includes:
a high-pass filter that removes or reduces, from the amplified first detection signal, a frequency component of a voltage energized to at least the first exciting coil; and
a second amplifier that amplifies the filtered first detection signal through the high-pass filter, and
a second amplification factor of the second amplifier is set based on the second detection signal and the set first amplification factor.

3. The control gate according to claim 1, further comprising:
a third exciting coil (i) that is disposed in another path which approaches to the position where the first exciting coil and from a different side to a position where the second exciting coil is disposed, and that forms a third alternating magnetic field; and
a third detection coil that detects a variation in the third alternating magnetic field by magnetic inversion of the magnetic material within the third alternating magnetic field formed by the third exciting coil,
wherein the amplification factor setting unit sets the first amplification factor for the first amplifier based on a third detection signal of the third detection coil when a person passes through the position where the third exciting coil is disposed and proceeds into the position where the first exciting coil is disposed.

4. The control gate according to claim 3, wherein
a first person-detection sensor is disposed in a position corresponding to the position where the first exciting coil is disposed,
a second person-detection sensor is disposed in a position corresponding to the position where the third exciting coil is disposed, and
wherein the amplification setting unit, when the first person-detection sensor detects a person, sets the first amplification factor for the first amplifier based on the first detection signal of the first exciting coil, or
the amplification setting unit, when the second person-detection sensor detects a person, sets the third amplification factor for the first amplifier based on the third detection signal of the third exciting coil.
